(19) United States
(12) Patent Application Publication
(10) Pub. No.: US 2009/0212505 A1
(43) Pub. Date: Aug. 27, 2009

(54) Heat staked shelf

(76) Inventors: Matthew J. McMillin, New Albany, IN (US); Eric Rouch, Louisville, KY (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 12/384,627

(22) Filed: Apr. 7, 2009

Related U.S. Application Data
(63) Continuation of application No. 10/514,199, filed on Jul. 7, 2005, now abandoned.
Application No. 10/514,199 is a continuation-in-part of application No. 10/375,632, filed on Feb. 27, 2003, now abandoned.
Application No. 10/375,632 is a continuation-in-part of application No. PCT/US03/02045, filed on Jan. 24, 2003.
(60) Provisional application No. 60/351,917, filed on Jan. 25, 2002.
(60) Provisional application No. 60/361,464, filed on Mar. 4, 2002.

(51) Int. Cl. F25D 23/00; F16J 15/10

(52) U.S. Cl. 277/650; 312/408

(57) ABSTRACT

A shelving assembly (920) is disclosed, with the shelving assembly (920) including a series of heat stake ribs (926). The ribs (926) may be hot formed and made pliable so as to be flexed for purposes of providing additional retention and support to a glass shelf panel (928). The glass shelf panel (928) is also secured to a plastic rim (922). Heat stake pads (942) may be utilized with the heat stake ribs (926). The heat stake ribs (926) may be deformed against the corresponding heat stake pads (942) so as to provide support for the glass shelf panel (928).

### CROSS-REFERENCE TO RELATED APPLICATIONS

This application is a continuation of U.S. patent application Ser. No. 10/514,199 filed Jul. 7, 2005, which is a continuation-in-part of U.S. patent application Ser. No. 10/375,632 filed 27 Feb., 2003 and an International Patent Application No. PCT/US03/02045 filed 24 Jan., 2003. The United States patent application and the International Application claim priority of U.S. Provisional patent application Ser. No. 60/351,917, filed 25 Jan., 2002, and U.S. Provisional Patent Application Ser. No. 60/361,464, filed 4 Mar., 2002.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The invention relates to shelving designs which may be adapted for use with refrigerators and other articles employing shelving and, more particularly, shelving having glass supported in part through the use of heat stake ribs.

2. Background Art

Previous types of shelving have been developed for use as refrigerator and other shelves. In designing refrigerator shelving, it is important to provide a means for permitting selected movement of the shelf within the refrigerator, in addition to providing adequate support for the shelf.

In addition to these design features, one problem which arises with respect to refrigerator shelving relates to spills. It would be advantageous to include means for containing spills. If spills are allowed to build up, they can readily harbor bacteria, mold and other materials which may contaminate food stuffs and the like.

Still further, it is advantageous to insure that shelf panels themselves are appropriately secured to a frame or other supporting means. In addition, it is advantageous if the means for supporting and appropriately securing the shelf panel to supporting frame members is relatively inexpensive and facilitates assembly.

Numerous shelving designs exist in the prior art. For example, Kane, et al., U.S. Pat. No. 5,564,809, issued Oct. 14, 1996, discloses an encapsulated shelf assembly with a shelf support supporting a panel. The panel has an edge and a one-piece member encapsulating the panel edge and a substantial majority of the shelf support. The shelf assembly may be formed in a mold apparatus which defines a mold cavity and uses a spacing plug to position the shelf support in a mold cavity of the apparatus in a location spaced from the sides of the mold cavity.

Herrmann, et al., U.S. Pat. No. 5,735,589, issued Apr. 7, 1998, discloses a shelf assembly for a refrigerator compartment which includes a member slidably supported for extension and retraction on a support. The shelf member includes slide members which are preferably molded as a rim on an article support surface. A guide member extends from at least one, and preferably both, of the side members to guide the sliding movement. A stop on the guide member limits travel by engaging a limit surface on the shelf support.

Bird, et al., U.S. Pat. No. 5,454,638, issued Oct. 3, 1995, discloses adjustable refrigerator shelving having a shelf rail for supporting a partial width shelf within a refrigerator compartment on first and second, spaced shelf racks vertically oriented in the compartment. The tracks releasably engage with a number of support brackets for cantilever support of one or more shelves at a plurality of vertically spaced locations. The shelf rail includes rearwardly projecting hooks at each of the two opposing ends for releasable engagement with the shelf tracks. Locking tabs are included on the hooks to retain the shelf rails on the track, while a rub strip is provided between the partial shelf and the shelf rail, along a top edge of the shelf rail.

Bird, et al., U.S. Pat. No. 5,429,433, issued Jul. 4, 1995, describes a refrigerator shelf which is adapted for containment of spills on the shelf. The shelf includes a planer shelf member with a rim molded around the perimeter edge of the shelf member to form a liquid tight seal between the rim and the shelf member. The molded rim projects above the top surface of the shelf member to form a liquid dam for containing spills on the shelf member. In one embodiment, the shelf is slidably mounted to allow horizontal extension of the shelf, with access to the rear portion of the shelf using slide guides molded into the rim along each side of the shelf. The shelf is cantilevered upon support brackets from the rear wall of a refrigerator to allow air flow around the shelf sides. The support brackets are adapted to support the shelf at a plurality of vertical positions.

Meier, et al., U.S. Pat. No. 6,120,720, issued Sep. 19, 2000, discloses a method of manufacturing a glass shelf with a plastic edge. The glass panel is placed on a cavity of a mold with a peripheral edge of the cavity corresponding to the peripheral edge of the glass panel. The cavity has side cavity portions, each housing one of the shelf brackets. Plastic material is injected into the cavity adjacent corners, so that the forces of the injected material are essentially self balancing around the peripheral edge of the glass panel. In this manner, the glass panel is maintained in a substantially mating conformity with the cavity to produce a relatively consistently contoured frame.

The foregoing is merely a sample of the various types of prior art references which currently exist with respect to refrigerator shelving.

### SUMMARY OF THE INVENTION

In accordance with the invention, a shelving assembly is adapted for use in a refrigerator and other articles employing shelving. The assembly includes a shelf panel composed of glass. A plastic rim is sized and configured in a manner so as to provide for the rim to be secured around at least a portion of the perimeter of the shelf panel. Securing means are adapted to be heated and made pliable so as to provide retention and support for the panel. The securing means can comprise a plurality of heat stake ribs positioned at various locations around the panel. In addition, the securing means can also include a plurality of heat stake pads. Each of the pads can be associated with a different one of the heat stake ribs. Alternatively, and also in accordance of the invention, the securing means can comprise at least one heat stake pad, with the heat stake pad associated with at least two of the heat stake ribs.

Further in accordance with the invention, the plurality of heat stake ribs can be configured so that at least two of the heat stake ribs are located adjacent each lateral side of the shelf panel. The securing means can further comprise a plurality of heat stake pads, with one of each of the heat stake pads being associated with all of the heat stake ribs adjacent a lateral side of the shelf panel.

In accordance with further aspects of the invention, the securing means can comprise at least one heat stake rib initially projecting downwardly from the plastic rim. The heat stake rib can be adapted to be heated and made pliable, and while in a pliable state turned inwardly and below the perimeter of the shelf panel, so that at least a portion of the heat stake rib abuts an underside of the shelf panel. The heat stake rib can be formed around the perimeter of the shelf panel through the use of a small radius tool. Alternatively, the heat stake rib can be formed around the perimeter of the shelf panel through the use of a large radius tool.

Other aspects of the invention include the securing means having at least one heat stake rib initially projecting downwardly from the plastic rim, with at least one heat stake pad adapted to be in position on the heat stake rib and the heat stake rib is heated so as to be made pliable. When the heat stake rib is heated to an appropriate temperature, directed pressure may be exerted against the heat stake rib, so as to secure at least a portion of the heat stake pad against an underside portion of the shelf panel. The heat stake pad can include an aperture extending through the heat stake pad, with the aperture sized so as to receive the heat stake rib. The heat stake rib can be heated and received within the aperture of the heat stake pad, thereby making the heat stake rib pliable. When the heat stake rib is sufficiently pliable, the heat stake rib can be deformed against an underside of the heat stake pad, so as to cause the heat stake pad to abut an underside of the shelf panel.

Further in accordance with the invention, the securing means can comprise at least two heat stake pads, each of the pads having an L-shaped configuration. Still further, at least two heat stake pads can include a plurality of apertures extending therethrough. Each of the apertures is sized so as to receive one of the heat stake ribs.

The shelving assembly can also include means comprising an adhesive located intermediate to the plastic rim in the shelf panel. The adhesive provides for a leak-proof seal between the plastic rim and the shelf panel. The adhesive also rigidly secures the plastic rim to the shelf panel. The retention support provided by the securing means is additional to any retention and support provided through use of the adhesive.

The shelving assembly may be stationary or may facilitate sliding movement, as desired, on a ribbed liner of a refrigerator. The plastic rim can extend around the entirety of the periphery of the shelf panel. The plastic rim can be of an unitary and integral design. The plastic rim can comprise an upwardly projecting backstop extending across the entirety of the rear portion of the rim. Still further, the plastic rim can comprise a downwardly projecting forward lip having an acute cross section. This lip can act in part as a bumper to prevent damage of the shelving assembly from articles that may be knocked against a forward portion of the shelving assembly. This further acts in part as a handle to facilitate stationary positioning or a sliding movement on a plastic ribbed liner of a refrigerator.

The plastic rim can include a horizontally disposed section. A downwardly projecting section can be integral with the horizontally disposed section. An additional downwardly projecting section can also be integral with the horizontally disposed section. The combination of the horizontally disposed section, downwardly projecting section and additional downwardly projecting section form a groove. Still further, the horizontally disposed section can project inwardly and terminate in a flat plane. The flat plane can provide for a spacial area formed between a lower surface of the horizontally disposed section and an upper surface of the glass shelf panel. The adhesive is provided within the spacial area, and is utilized to facilitate securing of the glass shelf panel to the plastic rim.

The shelving assembly can further include at least one slot between the plastic rim and the shelf panel. The plastic rim can include a flat plane. Within the slot, the adhesive can be provided to as to secure and couple together the glass shelf panel and the plastic rim, while providing a leak-proof barrier to liquids. The slot also aids in the flow of the adhesive during the manufacturing process. The adhesive can comprise a reactive polyurethane hot melt or light cured acrylic adhesive.

Further in accordance with the invention, the shelving assembly can include a horizontally disposed lower ledge depending from a downwardly projecting member of the plastic rim. A plastic stop can be provided which depends downwardly or upwardly, as desired, from the horizontally disposed lower ledge. The shelf panel can also include decorative means for concealing the view of the adhesive. Still further, the shelf panel can be decorated with frosting or etching, so as to conceal viewing of the adhesive.

In accordance with other aspects of the invention, the shelving assembly can include a metal frame for supporting the glass shelf panel and the plastic rim. The shelving assembly can also include means for providing slidable movement of the shelf panel relative to the metal frame. The metal frame can include a forward and substantially horizontally disposed frame member. A further substantially horizontally disposed frame member can be positioned to the rear of the metal frame. The frame can further include a pair of opposing and parallel side plates, and means for coupling the frame members to the side plates. Each of the side plates can include means for removably locking the shelving assembly to walls of the refrigerator and other articles.

The plastic rim can extend around the entirety of the periphery of the shelf panel. The plastic rim can be of a unitary and integral design, and can comprise an upwardly projecting backstop extending across the entirety of a rear portion of the rim. The metal frame can include a pair of opposing and parallel side plates, with each of the side plates comprising an outwardly or inwardly projecting section, or it can be flat as desired. Each of the flat, outwardly or inwardly projecting sections can be received onto grooves of the plastic rim. The slidable movement can be achieved without requiring any additional modifications to the shelving assembly. The shelving assembly can include a depending metal protrusion. The combination of the metal protrusions and the plastic stop can provide for a stop mechanism for sliding movement of the shelving assembly. The metal protrusion can be punched out, formed or fastened so as to be horizontally or vertically depending.

In accordance with further aspects of the invention, the shelving assembly can be stationary and include sideplates which comprise a cantilever or a metal frame. The sideplates are attached to the plastic rim by screws, molded into the plastic rim or snapped onto the plastic rim. A plastic engagement mechanism can be provided, extending across a front or a rear portion of the shelving assembly. The engagement mechanism can include a fitted slot for capturing a front or rear frame member, as desired, in a snap-fit configuration. The front or rear frame member can be coupled to the remaining portions of the metal frame. Still further, the shelving assembly can include a rear plastic rail. The rail can have a downwardly projecting section. Positioned at a terminating end of the downwardly projecting section is a horizontally disposed section. This section is substantially perpendicular to the downwardly projecting section. The downwardly projecting member and the horizontally disposed member form a slot. The shelving assembly can include a rear frame member, interconnected to the sideplates, and located within the slot formed in the rear plastic rail.

### BRIEF DESCRIPTION OF THE SEVERAL VIEWS OF THE DRAWING

The invention will now be described with reference to the drawings, in which:

FIG. 1 is a plan view of a first embodiment of a shelving assembly in accordance with the invention;

FIG. 2 is a rear elevation view of the embodiment of the shelving assembly as shown in FIG. 1 in accordance with the invention;

FIG. 3 is an underneath side elevation view of the first embodiment of the shelving assembly shown in FIG. 1, in accordance with the invention;

FIG. 4 is a perspective view of the first embodiment of the shelving assembly as shown in FIG. 1, in accordance with the invention;

FIG. 5 is a sectional, elevation view taken along section lines 5-5 of FIG. 1, illustrating certain principles of interconnection of elements of the shelving assembly in accordance with the invention;

FIG. 6 is a side sectional view taken substantially through the middle of the first embodiment of the shelving assembly, along section lines 6-6 of FIG. 1, with the sectional view also partially cut away in the middle;

FIG. 7 is an enlarged view of the first embodiment of the shelving assembly in accordance with the invention, and consisting of an enlargement of FIG. 5;

FIG. 8 is a perspective view of a metal cantilever frame which may be employed with the first embodiment of the shelving assembly in accordance with the invention;

FIG. 9 is a perspective view of the first embodiment of the shelving assembly in accordance with the invention, illustrating the sliding feature of the glass shelf relative to the metal frame;

FIG. 10 is a sectional view similar in perspective and structure to FIG. 7, and illustrating a cross-sectional view of a second embodiment of a partial shelving assembly in accordance with the invention, illustrating the interconnection of a plastic rim with snaps and glass, and further illustrating the relationship of these elements with an outwardly projecting sideplate;

FIG. 11 is a cross-sectional view similar in perspective and content to the views of FIGS. 7 and 10, and illustrates an additional embodiment of a partial shelving assembly in accordance with the invention, and particularly directed to the feature of employing an inwardly projecting sideplate with the shelving assembly;

FIG. 12 is a similar view of a partial structure embodiment of the shelving assembly in accordance with the invention as illustrated in FIG. 11, and showing the relative position of one of the snap features;

FIG. 13 illustrates a plan view of a non-cantilever or metal frame embodiment of a shelving assembly in accordance with the invention;

FIG. 14 is a side elevation view of the embodiment of the shelving assembly as shown in FIG. 13, in accordance with the invention;

FIG. 15 is a perspective view of the embodiment of the shelving assembly as shown in FIG. 13, in accordance with the invention;

FIG. 16 is a rear elevation view of the shelving assembly as shown in FIG. 13, in accordance with the invention;

FIG. 17 is a rear elevation view of the shelving assembly as shown in FIG. 13 that utilizes snaps, in accordance with the invention;

FIG. 18 is a sectional, elevation view taken from the right side of FIG. 16, illustrating certain principles of interconnection of elements of the shelving assembly in accordance with the invention;

FIG. 19 is a sectional, elevation view taken from the right side of FIG. 17, illustrating the snap feature in accordance with the invention;

FIG. 20 is a sectional, front elevation view of a further embodiment of a shelving assembly in accordance with the invention, with this particular shelving assembly having a stationary glass shelf panel and plastic rim, and utilizing flat sideplates;

FIG. 21 is a sectional side, elevation view of the shelving assembly illustrated in FIG. 20, and showing the use of snaps (such as the snaps illustrated in FIG. 10 at various locations);

FIG. 22 is a partial sectional view, similar in structure to the left-side portion of the sectional view of FIG. 6, and illustrating the location of a front rail utilized with the shelving assembly of FIG. 20, and providing characteristics to maintain the glass shelf panel in a stationary position;

FIG. 23 is a partial sectional view, similar in structure to the right-side of the sectional view of FIG. 6, and illustrating the use of a rear plastic rail acting to hold the back of the shelf to the cantilever or metal frame at the rear frame member;

FIG. 24 is a perspective view of the shelving assembly first illustrated in FIG. 20;

FIG. 25 is an underside, perspective view of the shelving assembly illustrated in FIG. 24;

FIG. 26 is a partial sectional view, similar in content to the left-side portion of the sectional view of FIG. 6, and illustrating an alternate embodiment employing a support ledge as part of the plastic rim, for purposes of facilitating retention of the glass shelf, and for aiding in the assembly of the glass shelf panel, plastic rim and adhesive;

FIG. 27 is a sectional view similar in perspective and content to the views of FIGS. 7, 10, 11, and 12 and illustrating the use and relative positioning of a plastic stop which may be employed and utilized with the snaps, such as the snaps illustrated in FIG. 10;

FIG. 28 is an underside view of the metal protrusion and plastic stop that combine to provide a stop mechanism for the plastic rim and glass shelf panel assembly relative to a metal frame with sideplates;

FIG. 29 is a sectional view similar in perspective and content to the views of FIGS. 7, 10, 11, 12, and 27, and illustrating the use and relative positioning of a heat stake rib which may be utilized with the shelving assembly in accordance with the invention;

FIG. 30 is a sectional view similar to FIG. 29, but showing the heat stake rib curved so that a lower section thereof is flexed inwardly toward and below the glass shelf panel, with the heat stake rib being hot formed with a small radius tool;

FIG. 31 is a sectional view similar to FIG. 30, but showing the securing position of the heat stake rib after being hot formed with a large radius tool;

FIG. 32 is a sectional view similar to FIG. 29, but showing the use of a heat stake pad with the heat stake rib;

FIG. 33 is a sectional view of the heat stake pad and the heat stake rib of FIG. 32, but showing the heat stake rib after being heated and causing the heat stake pad to abut the lower portion of the glass shelf panel;

FIG. 34 is a perspective, underside view illustrating the relationship between a heat stake rib and a heat stake pad;

FIG. 35 is a perspective, underside view similar to FIG. 34, but showing a configuration where the heat stake rib is received within the aperture of the heat stake pad;

FIG. 36 is similar to FIG. 35, but shows a “final” configuration of the heat stake rib and heat stake pad after heating, with the heat stake pad abutting a lower portion of the shelf panel;

FIG. 37 is a partially perspective view of an elongated and alternative configuration of a heat stake pad, with the heat stake pad having an L-shaped configuration and a series of four apertures for receiving four corresponding heat stake ribs;

FIG. 38 is a plan view of a heat stake pad having an L-shaped configuration, and having a single aperture for receiving a single heat stake rib;

FIG. 39 is a section view of the heat stake pad illustrated in FIG. 38, taken along section lines 39-39 of FIG. 38; and

FIG. 40 is an end view of the heat stake pad illustrated in FIGS. 38 and 39.

### DETAILED DESCRIPTION OF THE INVENTION

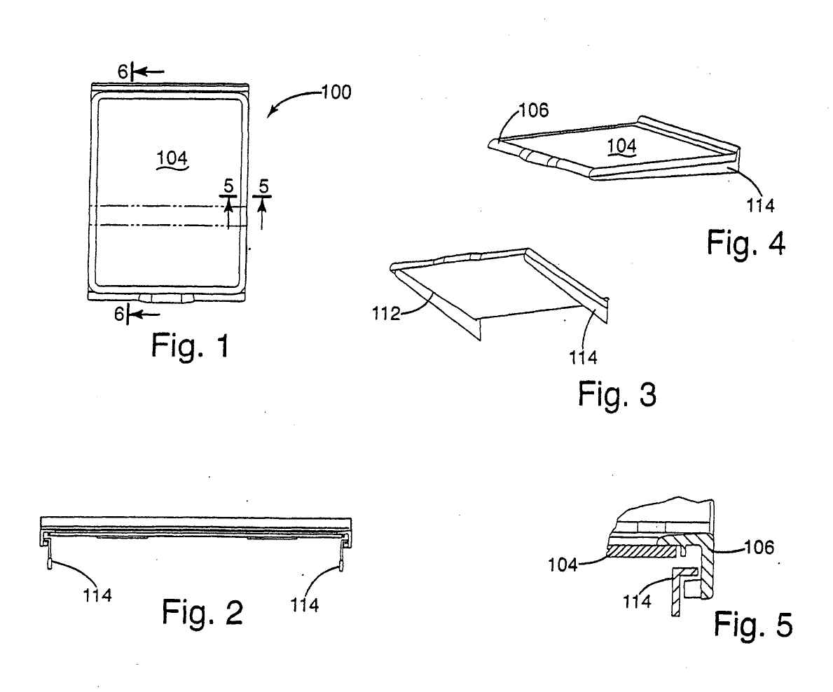

The principles of the invention are disclosed, by way of example, in certain embodiments of shelving assemblies in accordance with the invention, as illustrated in FIGS. 1-40. As described in subsequent paragraphs herein, the shelving assemblies in accordance with the invention employ an integral plastic rim comprising only a single piece of plastic, thereby cutting down on material usage and facilitating manufacturing processes. As also shown in particular embodiments of the invention in the drawings, snaps can be employed for purposes of adding retention and support for the glass shelf itself. Still further, and in accordance with the invention, the method of “joining” the glass shelf to the plastic rim, and the particular interface for the coupling of the same, provides significant advantages.

Still further, the shelving assembly can be manufactured in a manner such that the shelving assembly may have capability of slidable movement relative to a frame structure. The slidable feature cannot be provided in encapsulated or sonic welded shelving assemblies, without necessarily requiring any “special” add-on hardware or additional plastic molded onto the shelf assembly itself. In addition to the foregoing, the shelving assemblies in accordance with the invention may include means for containing liquid spillage in a leak-proof manner. In part, an adhesive is employed between the glass and plastic rim structures, so as to accomplish this spillage containment. Still further, traditional encapsulated and sonic welded shelving designs may include crevices which are substantially impossible to clean. Within such crevices, build up of food and spillage (with associated bacteria) may occur.

More specifically, in known shelving designs, it is not uncommon to include glass encapsulated within plastic. This is often referred to as encapsulated glass shelving, and is referenced in part in certain of the prior art references described in prior paragraphs herein. Encapsulated glass shelving has several disadvantages, compared to shelving assemblies in accordance with the invention. As earlier mentioned, shelving assemblies in accordance with the invention are relatively more sanitary than prior art shelving. For example, certain encapsulated glass shelving designs are not actually leak-proof, but instead are merely spill-resistant. Such designs will actually allow liquids to spill. The spill-resistant design only impedes speed at which the spill occurs to other shelves below in a refrigerator unit. Over time, such spills can result in a build up of dried fluids between cracks and crevices of the glass and plastic, allowing for growth of bacteria, mold and other harmful materials. Shelving assemblies in accordance with the invention significantly limit these concerns.

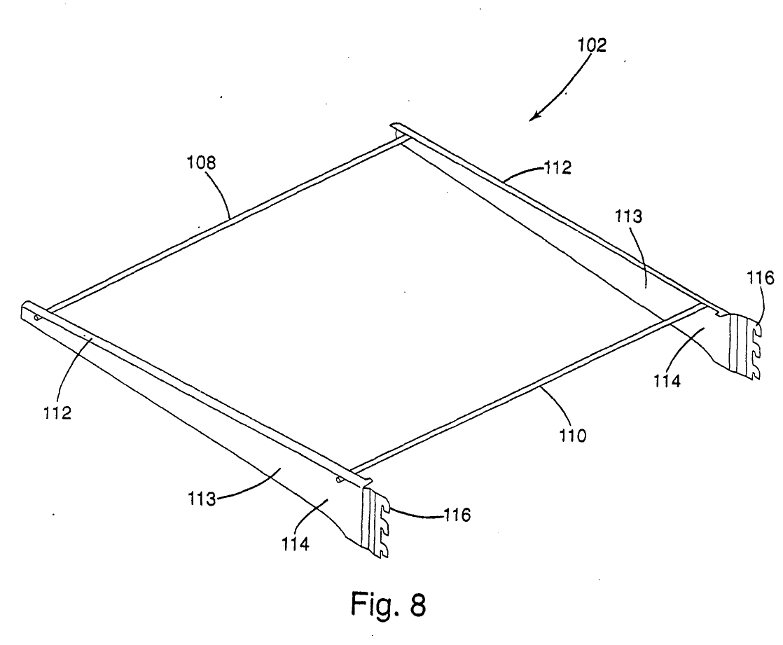

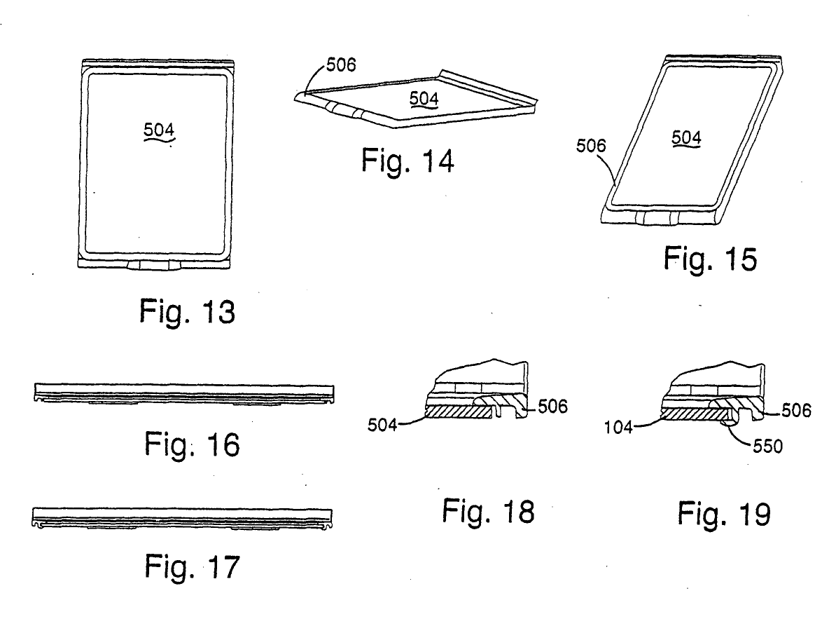

Turning to the drawings, the first embodiment of a shelving assembly in accordance with the invention that will be described is a shelving assembly 100 as illustrated in plan view in FIG. 1, and as further illustrated in FIGS. 2-9. Referring specifically to FIGS. 1-9, the shelving assembly 100 includes a cantilever or metal frame 102 (see FIG. 8). Although this particular embodiment of a shelving assembly in accordance with the invention as illustrated in FIGS. 1-9 utilizes a metal frame 102, it should be emphasized that other embodiments of shelving assemblies in accordance with this invention may consist of a shelving assembly without a metal frame 102. Such an assembly is shown, for example, in the shelving assembly in accordance with the invention as illustrated in FIGS. 13-19. Such an embodiment will be described in subsequent paragraphs herein. Returning to FIGS. 1-9, the metal frame 102 is used in part to support a glass shelf or glass shelf panel 104. In addition, the metal frame 102 is also used in part to support a plastic rim 106, which is also part of the shelving assembly 100 in accordance with the invention. As described in subsequent paragraphs herein, a concept in accordance with the invention is the securing of the glass shelf panel 104 to the plastic rim 106 through the use of an adhesive (described in subsequent paragraphs) throughout the entirety of the periphery of the glass shelf panel 104.

Returning to the metal frame 102, and referring primarily to FIG. 8, the metal frame 102 includes a forward and substantially horizontally disposed frame member 108. In addition, another substantially horizontally disposed frame member 110 is positioned to the rear of the metal frame 102. These frame members are coupled by any suitable means (not shown) to a pair of opposing and parallel sideplates 114. The sideplates 114 may include downwardly projecting side members 113. In addition, projecting outwardly from the upper portion of the downwardly side member 113 are outwardly projecting members or flanges 112. These outwardly projecting members 112 will serve purposes as described in subsequent paragraphs herein. Each of the sideplates 114 may include a hanger set 116 extending rearwardly from the corresponding sideplate 114. The hanger set 116 may be utilized as cantilever brackets of relatively conventional design, so as to removably lock the shelving assembly 100 into tracks (not shown) connected to walls of refrigerators or other assemblies to which the shelving assembly 100 is to be attached. These hanger sets 116 are conventional in design and do not form any of the novel concepts of the invention. Accordingly, various other means may be utilized for purposes of supporting the shelving assembly 100 on a wall or other article of manufacture, without departing from the spirit and scope of the invention.

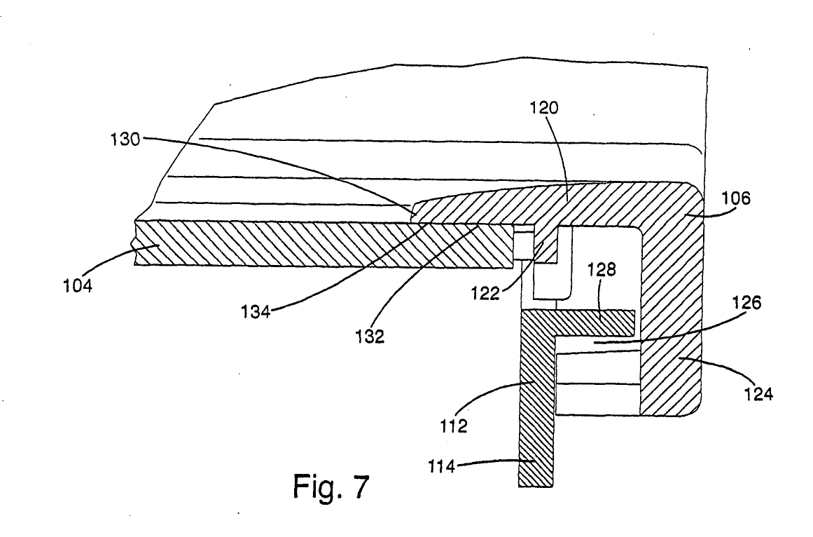

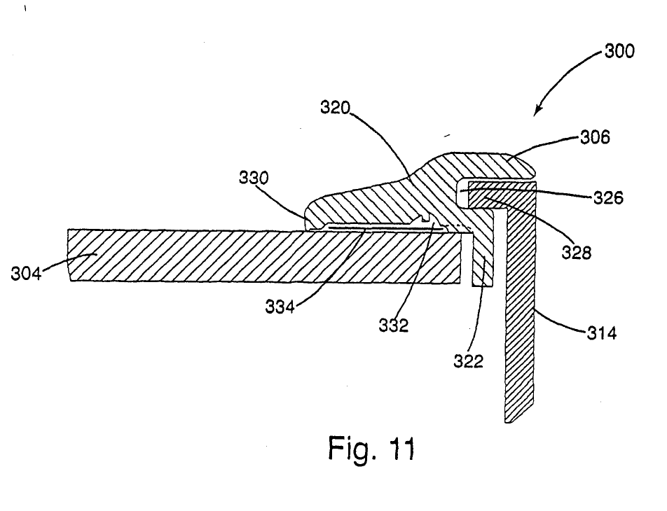

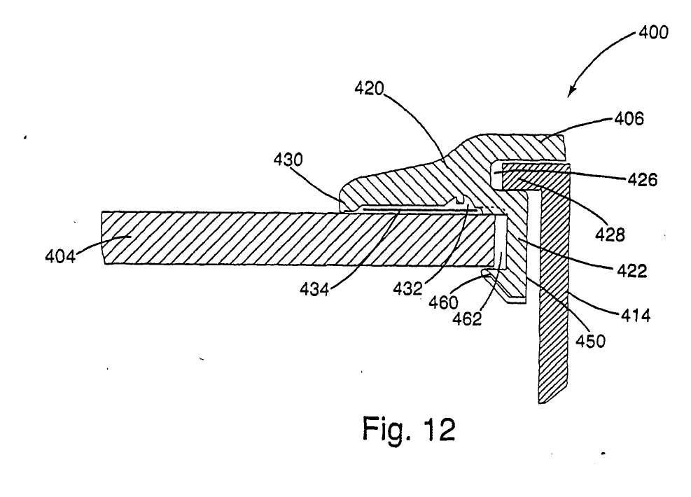

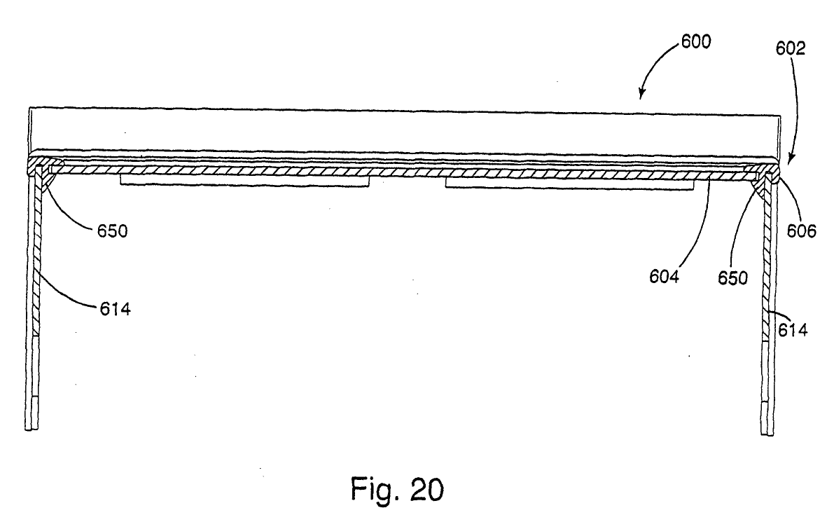

The glass shelf or glass shelf panel 104, and the plastic rim 106, may be appropriately supported on the metal frame 102. As shown primarily in FIG. 4, the plastic rim 106 will extend around the entirety of the periphery of the glass shelf or glass shelf panel 104. In this particular embodiment, the plastic rim 106 will have a cross-sectional configuration as primarily illustrated in FIGS. 5 and 7. However, other cross-sectional configurations of the plastic rim 106 may be utilized without departing from the novel concepts and spirit and scope of the invention. More specifically, the plastic rim 106 includes a horizontally disposed section 120. Extending downwardly, and integral with the horizontally disposed section 120, is a downwardly projecting section 122. Also extending downwardly, and integral with the horizontally disposed section 120, is another downwardly projecting section 124. The combination of the horizontally disposed section 120, downwardly projecting section 122, and downwardly projecting section 124, forms a slide space 126. Turning again to the sideplate 114, and as illustrated in FIG. 7, the sideplate 114 may include an outwardly projecting section 128, which may be received within the slide space 126. The outwardly projecting section 128 may correspond with the horizontally disposed and outwardly directed flange or member 112 previously described with respect to FIG. 8. Although this particular embodiment of a shelving assembly in accordance with the invention as illustrated in FIG. 7 utilizes a sideplate 114 with an outwardly projecting member 128, it should be emphasized that other embodiments of shelving assemblies in accordance with the invention may utilize an inwardly projecting member or a completely “flat” sideplate 114. An inwardly projecting member is shown, for example, in the shelving assembly in accordance with the invention as illustrated in FIGS. 11 and 12. A “flat” sideplate is shown, for example, in the shelving assembly in accordance with the invention as illustrated in FIGS. 20-25. “Inwardly projecting sideplates” and “flat sideplate” embodiments will be described in subsequent paragraphs herein.

As earlier stated, the plastic rim 106 includes a substantially horizontally disposed section 120, again as illustrated in FIGS. 5 and 7. As also earlier stated, the plastic rim 106 extends around the entirety of the periphery of the shelving assembly 100. The horizontally disposed section 120 projects inwardly and terminates in a downwardly projecting lip 130, again as illustrated primarily in FIG. 7. As further illustrated in FIG. 7, the relative structure of the downwardly projecting lip 130 provides for a spacial area 132 formed between the lower surface of the horizontally disposed section 120 and the upper surface of the glass shelf panel 104. Within this spacial area 132, an appropriate adhesive 134 is provided within the spacial area 132, and is utilized to facilitate securing of the glass shelf panel 104 to the plastic rim 106. This adhesive 134 may be utilized around the entire periphery of the glass shelf or glass shelf panel 104. In addition to providing a means for securing the glass shelf panel 104 to the plastic rim 106, the adhesive 134 also acts as a leak-proof barrier, preventing spillage from seeping down to lower shelves or other surfaces around the periphery of the glass shelf panel 104. Further, with the use of the adhesive 134, as opposed to traditional encapsulation and sonic welding procedures, build up of food and spills (with resultant bacteria) do not occur within crevices that are substantially incapable of being cleansed. In substantial part, the unitary design of the plastic rim 106 in accordance with the invention provides these advantages.

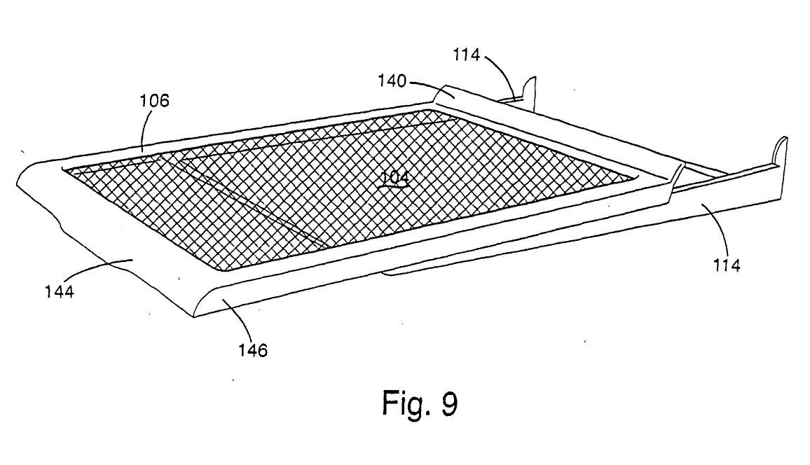

As earlier stated, the glass shelf or glass shelf panel 104, interconnected with the plastic rim 106, may have capability of sliding relative to the metal frame 102. The sliding action can occur through the relative coupling of the outwardly projecting member 128 of the sideplate 114 to the plastic rim 106 through the slide space 126. The shelving assembly 100 with the glass shelf 104 and plastic rim 106 in a relatively extended position is illustrated in FIG. 9. As will be described in subsequent paragraphs herein, the shelving assemblies in accordance with the invention may include “stop” designs having the capability of preventing the glass shelf panel 104 and plastic rim 106 from completely sliding “out of” the metal frame 102. Certain embodiments of “stop” designs in accordance with the invention are described in subsequent paragraphs. However, other “stop” means of preventing the glass shelf panel 104 and plastic rim 106 from sliding completely out of the metal frame 102 may be utilized, without departing from the novel concepts and spirit and scope of the invention. In addition, other embodiments of shelving assemblies in accordance with the invention may be stationary and not have the capability of sliding. Such a shelving assembly in accordance with the invention is illustrated in FIGS. 20-25. Such an embodiment will be described in subsequent paragraphs herein.

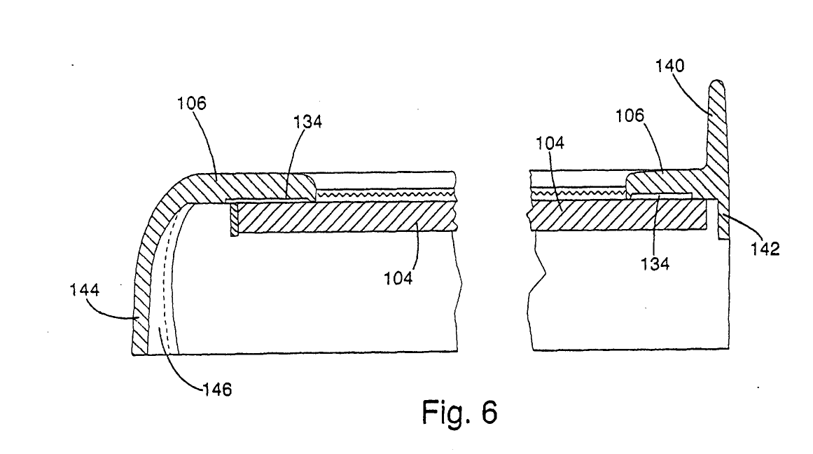

The plastic rim 106 also includes other structural configurations at forward and rearward locations of the shelving assembly 100. For example, and as primarily illustrated in FIG. 6, the plastic rim 106 may include an upwardly projecting “backstop” 140 extending across the entirety of the rear portion of the plastic rim 106. The plastic rim 106 may also include a downwardly projecting member 142 extending across the rear portion or around the entire underside of the shelving assembly 100, as is desired. Downwardly projecting member 142 also acts as a positioning aid for the glass shelf panel 104 during manufacturing. As previously described, the plastic rim 106 is of a single, unitary design. Therefore, the upwardly projecting backstop 140 and downwardly projecting member 142 are integral with the remaining portions of the plastic rim 106. The shelving assembly 100 described herein with respect to the backstop 140 may also utilize various other “backstop” designs, without departing from the novel concepts and the spirit and scope of the invention.

At the forward area of the plastic rim 106, the plastic rim 106 includes a downwardly projecting forward lip 144, having an arcuate cross section as illustrated in FIG. 6. The downwardly projecting lip 144 acts in part as a “bumper” to prevent damage of shelving assembly 100 from articles which may be “knocked against” the forward portion of the shelf assembly 100. In addition to the “bumper” features of the projecting lip 144, the projecting lip 144 may also act as a manually operable handle, so that a user may slide the shelf panel 104 and plastic rim 106 forward or rearward of the metal frame 102, for purposes of extending and retracting the assembly, respectively. The forward portion of the plastic rim 106 may also include side members 146 (see FIGS. 6 and 9), again for purposes of protection. The first embodiment of a shelving assembly in accordance with the invention has now been described with respect to shelf assembly 100. In particular, the shelf assembly 100 in accordance with the invention includes an integrally formed plastic rim 106, glass shelf panel 104 and metal frame 102. As previously described, an adhesive 134 facilitates securing of the glass shelf panel 104 to the plastic rim 106. In addition, the adhesive 134 acts as a leak-proof barrier against spillage seeping off of the glass shelf panel 104. This adhesive 134, in combination with the unitary structure of the plastic rim 106, also assists in preventing build up of food particles and fluids within cracks or crevices which cannot readily be cleaned. Accordingly, this design also limits build up of bacteria.

Still further, the shelving assembly 100 in accordance with the invention cuts down material usage and facilitates speeding up of manufacturing processes, in view of the integral design of the plastic rim 106. As previously discussed, the coupling of the glass panel 104 to the plastic rim 106 and the integral construction of the plastic rim 106 significantly differs from current methods of completely encapsulating glass shelving within plastic, or the use of top and bottom pieces of plastic sonically welded around glass. Still further, and as described with respect to the shelving assembly 100, the glass shelf 104 and plastic rim 106 can slide on the metal frame 102. This sliding movement is substantially incapable of being accomplished in encapsulated or sonic welded shelving assembly, without the addition of special add-on hardware or additional plastic molding associated with the shelf.

Further in accordance with the invention, various types of adhesives may be employed. To illustrate, two types of adhesives that may be utilized are a polyurethane hot melt or a light cured acrylic adhesive. However, various types of adhesives may be utilized without departing from the spirit and scope of the novel concepts of the invention.

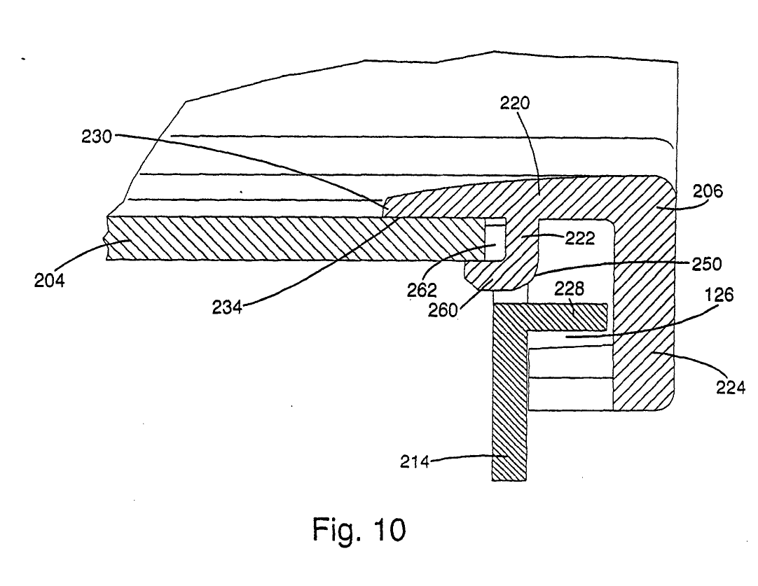

A second embodiment of a shelving assembly in accordance with the invention is illustrated in part as shelving assembly 200 in FIG. 10. For purposes of clarity and brevity, the entirety of the shelf assembly 200 is not illustrated. The shelf assembly 200 is substantially similar in design and construction to shelf assembly 100 previously described with respect to FIGS. 1-9. The distinctions between shelf assembly 100 and shelf assembly 200 are primarily shown in FIG. 10, which is similar in perspective and content to FIGS. 5 and 7 associated with shelf assembly 100. More specifically, with shelf assembly 200, a metal frame is provided which includes a sideplate 214. The sideplate includes an outwardly projecting tab 228 at its upper portion. The outwardly projecting tab 228 is integral with the sideplate 214. The shelving assembly 200 further includes a plastic rim 206, similar in structure and function to the plastic rim 106 also previously described with respect to FIG. 7. The plastic rim 206 includes a horizontally disposed section 220. Extending downwardly, and integral with the horizontally disposed section 220, is a downwardly projecting section 222. Also extending downwardly, and integral with the horizontally disposed section 220, is another downwardly projecting section 224. The combination of the horizontally disposed section 220, downwardly projecting section 222, and downwardly projecting section 224, forms a slide space 226. The sideplate 214 may include an outwardly projecting section 128, which may be received with in the slide space 226. The slide space 226 has the same function as slide space 126 as illustrated in FIG. 7, with respect to shelving assembly 100. That is, the slide space 226 provides for a slidable coupling and support of the plastic rim 206 with the sideplate 214, through the outwardly projecting tab 228 of the sideplate 214. As with the assembly 100, the shelving assembly 200 also includes a spacial area 232 formed between the plastic rim 206 and a glass shelf or glass shelf panel 204, with the plastic rim 206 having a downwardly projecting lip 230. Within the spatial area 232, an adhesive 234 is provided so as to secure and couple together the glass shelf panel 204 and the plastic rim 206. Distinguishable from the shelving assembly 100 in accordance with the invention, the shelving assembly 200 includes one or a series of snaps 250 which may be positioned at various locations on the underside of the front, back, and sides (or combinations thereof) of the plastic rim 206. A snap 250 is formed through the use of a horizontally disposed ledge 260 as illustrated in FIG. 10. The horizontal disposed ledge 260 is preferably formed integral with the downwardly projecting section 222 of the plastic rim 206, at certain positions along the plastic rim 206. The horizontally disposed section 220, downwardly projecting section 222 and horizontally disposed ledge 260 are sized so as to form a slot 262 as shown in FIG. 10. The slot 262 is appropriately sized so as to provide a “snap-fit” coupling of the edge of the glass shelf or glass shelf panel 204 with the snap 250 through the slot 262. In accordance with the invention, the snap 250 may be utilized to provide additional retention and support for the glass shelf or glass shelf panel 204.

The foregoing description of the shelving assembly 200 describes the primary features of shelving assembly 200 which distinguish from the shelving assembly 100. However, both the shelving assembly 100 and the shelving assembly 200 comprise shelf assemblies in accordance with the invention.

Additional features of alternative embodiments of a shelving assembly in accordance with the invention are illustrated in FIGS. 11 and 12. Referring specifically to FIG. 11, the drawing of FIG. 11 illustrates, in part, an alternate cross-section of the plastic rim 306 utilizing an inwardly projecting sideplate 314. Shelving assembly 300 consists of a plastic rim 306, glass shelf panel 304, and metal frame (not shown for brevity purposes) similar to the metal frame shown in FIG. 8. More specifically, the plastic rim 306 includes a horizontally disposed section 320. Extending downwardly, and integral with the horizontally disposed section 320, is a downwardly projecting section 322. The combination of the horizontally disposed section 320 and the downwardly projecting section 322 forms a slide space 326. The sideplate 314 may include an inwardly projecting section 328, which may be received within the slide space 326.

Similar to the shelving assembly 100 illustrated in FIG. 7, shelving assembly 300 has a plastic rim 306 that extends around the entirety of the periphery of the shelving assembly 300. The horizontally disposed section 320 projects inwardly and terminates in a downwardly projecting lip 330 as seen in FIG. 11. As further illustrated in FIG. 11, the relative structure of the downwardly projecting lip 330 provides for a spacial area 332 formed between the lower surface of the horizontally disposed section 320 and the upper surface of the glass shelf panel 304. Within this spacial area 332, an appropriate adhesive 334 is provided and is utilized to facilitate securing of the glass shelf panel 304 to the plastic rim 306. This adhesive 334 may be utilized around the entire periphery of the glass shelf or glass shelf panel 304. In addition to providing a means for securing the glass shelf panel 304 to the plastic rim 306, the adhesive 334 also acts as a leak-proof barrier, preventing spillage from seeping down to lower shelves or other surfaces around the periphery of the glass shelf panel 304. Further, with the use of the adhesive 334, as opposed to traditional encapsulation and sonic welding procedures, build up of food and spills (with resultant bacteria) do not occur within crevices that are substantially incapable of being cleansed. In substantial part, the unitary design of the plastic rim 306 in accordance with the invention provides these advantages.

The glass shelf or glass shelf panel 304, interconnected with the plastic rim 306, may have capability of sliding relative to the metal frame. The sliding action can occur through the relative coupling of the inwardly projecting member 328 of the sideplate 314 to the plastic rim 306 through the slide space 326. The shelving assembly 300 with the glass shelf 304 and plastic rim 306 could have a similar extended position as previously seen in FIG. 9. Again, as will be described in subsequent paragraphs herein, the shelving assemblies in accordance with the invention may include “stop” designs having the capability of preventing the glass shelf panel 304 and plastic rim 306 from completely sliding “out of” the metal frame. Certain embodiments of “stop” designs in accordance with the invention are described in subsequent paragraphs. However, other “stop” means of preventing the glass shelf panel 304 and plastic rim 306 from sliding completely out of the metal frame may be utilized, without departing from the novel concepts and spirit and scope of the invention.

An additional embodiment is described as shelving assembly 400 as seen in FIG. 12. For purposes of clarity and brevity, the entirety of the shelf assembly 400 is not illustrated. The shelf assembly 400 is substantially similar in design and construction to shelf assembly 300 previously described with respect to FIG. 11. The distinctions between shelf assembly 300 and shelf assembly 400 are primarily shown in FIG. 12, which is similar in perspective and content to FIGS. 5 and 7 associated with shelf assembly 100. More specifically, with shelf assembly 400, a metal frame is provided which includes a sideplate 414. The sideplate includes an inwardly projecting tab 428 at its upper portion. The inwardly projecting tab 428 is integral with the sideplate 414. The shelving assembly 400 further includes a plastic rim 406, similar in structure and function to the plastic rim 306 also previously described with respect to FIG. 11. The plastic rim 406 includes a horizontally disposed section 420. Extending downwardly, and integral with the horizontally disposed section 420, is a downwardly projecting section 422. The combination of the horizontally disposed section 420 and downwardly projecting section 422, forms a slide space 426. The sideplate 414 may include an inwardly projecting section 428, which may be received with in the slide space 426. The slide space 426 has the same function as slide space 326 as illustrated in FIG. 11, with respect to shelving assembly 300. That is, the slide space 426 provides for a slidable coupling and support of the plastic rim 406 with the sideplate 414, to an inwardly projecting member 428 of the sideplate 414. As with the assembly 300, the shelving assembly 400 also includes a spacial area 432 formed between the plastic rim 406 and a glass shelf or glass shelf panel 404, with the plastic rim 406 having a downwardly projecting lip 430. Within the spatial area 432, an adhesive 434 is provided so as to secure and couple together the glass shelf panel 404 and the plastic rim 406. Distinguishable from the shelving assembly 300 in accordance with the invention, the shelving assembly 400 includes one or a series of snaps 450 which may be positioned at various locations on the underside of the front, back, and sides (or combinations thereof) of the plastic rim 406. A snap 450 is formed through the use of a horizontally disposed ledge 460 as illustrated in FIG. 12. The horizontal disposed ledge 460 is preferably formed integral with the downwardly projecting section 422 of the plastic rim 406, at certain positions along the plastic rim 406. The horizontally disposed section 420, downwardly projecting section 422 and horizontally disposed ledge 460 are sized so as to form a slot 462 as shown in FIG. 12. The slot 462 is appropriately sized so as to provide a “snap-fit” coupling of the edge of the glass shelf or glass shelf panel 404 with the snap 450 through the slot 462. In accordance with the invention, the snap 450 may be utilized to provide additional retention and support for the glass shelf or glass shelf panel 404.

The foregoing description of the shelving assembly 400 describes the primary features of shelving assembly 400 that distinguish it from the shelving assembly 300. However, both the shelving assembly 300 and the shelving assembly 400 comprise shelf assemblies in accordance with the invention.

Additional embodiments are illustrated in FIGS. 13-19. FIGS. 13-19 are embodiments that do not include a cantilever or metal frame 102 as described in FIG. 8. These embodiments utilize similar features as described in shelving assemblies 100, 200, 300, and 400 with the exception of the metal frame. FIGS. 13-19 contain a plastic rim 506 and glass shelf panel 504. The shelving assembly 500 illustrated in FIGS. 13-19 can be placed on various types of support structures such as a ribbed liner of a refrigerator (not pictured) or other similar support structures. For some applications, a metal frame may be rendered useless or unusable with the type of shelving assemblies previously described herein. In those circumstances the shelving assembly 500 without a metal frame as illustrated in FIGS. 13-19 may be utilized. FIG. 16 illustrates a rear view of the shelving assembly 500 and FIG. 18 represents a cross-section of the right side of FIG. 16, similar to FIGS. 7 and 11. FIG. 17 illustrates an additional embodiment showing the rear view of shelving assembly 500 with snaps and FIG. 19 represents a cross-section of the right side of FIG. 17 utilizing snaps 550, similar to FIGS. 10 and 12. While FIGS. 17 and 19 represent cross-sections in accordance with the invention, other cross-sectional configurations of the plastic rim 506 may be utilized without departing from the novel concepts and spirit and scope of the invention.

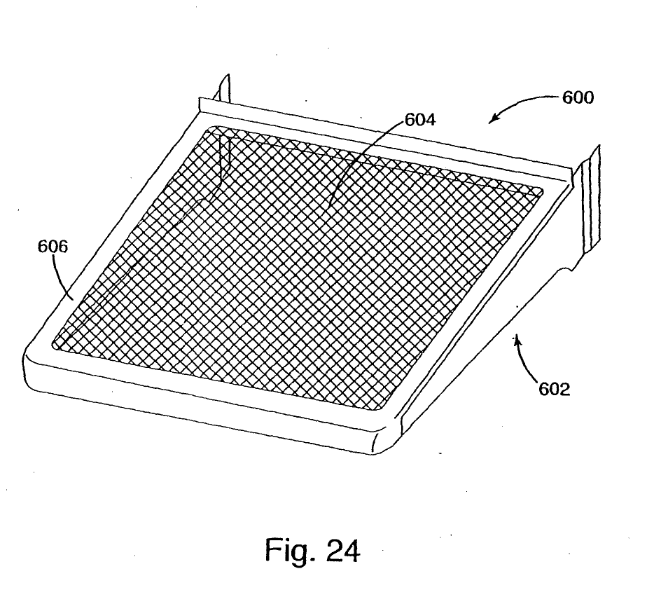

The various embodiments of shelving assemblies in accordance with the invention which have been described in the foregoing paragraphs have commonality with respect to their capability of exhibiting sliding characteristics for the glass shelf panels. Concepts in accordance with the invention relating to the use of glass shelf panels with plastic rims interconnected as discussed herein may also be applied to shelving assemblies which maintain the glass shelf panels in a stationary position, relative to surrounding frame structures. For example, a stationary shelving assembly having features in accordance with the invention is shown in shelving assembly 600, illustrated in FIGS. 20-25. With reference first to FIG. 24, the shelving assembly 600 includes components substantially similar in function and structure to components illustrated and described in prior paragraphs with respect to other shelving assemblies in accordance with the invention. That is, the shelving assembly 600 includes a metal frame 602, used in part to support a glass shelf or glass shelf panel 604. The metal frame 602 is also used in part to support a plastic rim 606, which is part of the shelving assembly 600 in accordance with the invention. In a manner previously described herein with respect to other shelving assemblies in accordance with the invention, the glass shelf panel 604 is preferably secured to the plastic rim 606 with the use of an adhesive (as described in previous paragraphs) throughout the entirety of the periphery of the glass shelf panel 604.

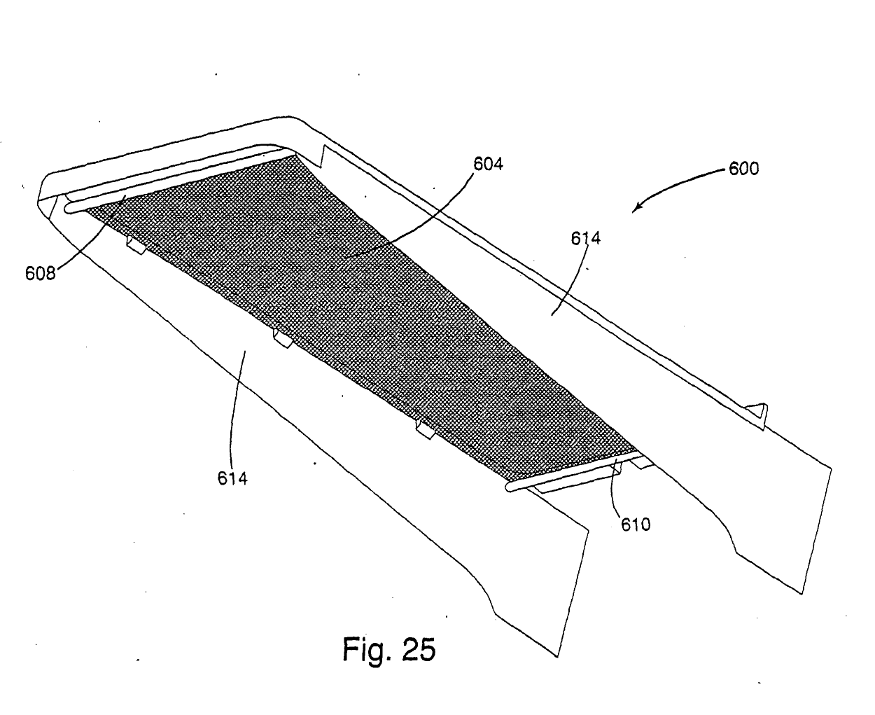

As shown particularly in the underside view of the shelving assembly 600 in FIG. 25, the shelving assembly 600 (again, like other shelving assemblies previously described herein) includes a forward and substantially horizontally disposed frame member 608. In addition, another substantially horizontally disposed frame member 610 is positioned to the rear of the metal frame 602. These frame members 608, 610 are coupled to other structures of the shelving assembly 600 as described in subsequent paragraphs herein. Additional metal frame or sideplate attachment options may be utilized without departing from the spirit and scope of the novel concepts of the invention. For example, screw on sideplates, molded in sideplates, and snap on sideplates (all utilized in tandem with the plastic rim) may be utilized in accordance with the invention.

The shelving assembly 600 in accordance with the invention also includes a pair of opposing sideplates 614. In the particular embodiment illustrated in FIGS. 20-25, the sideplates 614 are shown as flat sideplates which depend vertically downward from the shelving assembly 600. With the particular shelving assembly 600 in accordance with the invention having stationary shelf characteristics, the sideplates 614 may also be formed as inwardly or outwardly projecting sideplates.

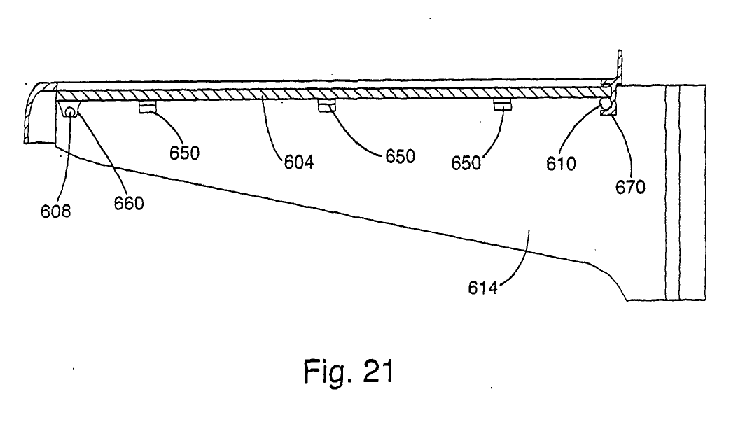

With reference specifically to FIG. 21, the shelving assembly 600 in accordance with the invention can utilize a series of snaps 650 on the sides of the shelving assembly 600. The snaps 650 can correspond in function and structure to the snaps 250 previously described with respect to FIG. 10.

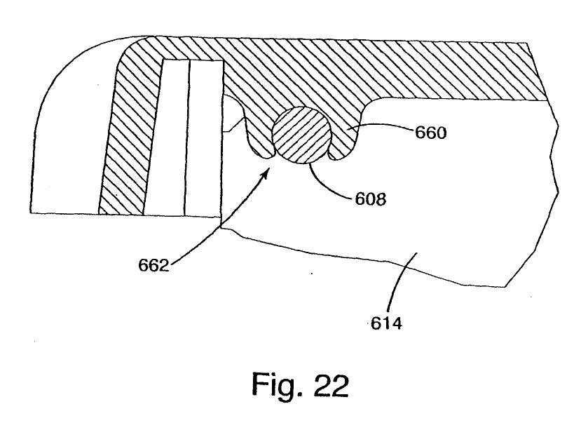

With reference to FIG. 22, the shelving assembly 600 in accordance with the invention may include a plastic engagement mechanism 660. The plastic engagement mechanism 660 is of a cross-sectional configuration as illustrated in FIG. 22. The plastic engagement mechanism 660 extends across the front portion of the shelving assembly 600. The plastic engagement mechanism 660 is of a resiliency and includes a fitted slot 662 which is used to “capture” the front frame member 608 in a “snap fit” configuration. With the forward frame member 608 coupled to remaining portions of the metal frame 602 in a manner previously described with respect to other shelving assemblies in accordance with the invention, the capture of the frame member 608 by the plastic engagement mechanism 660 maintains the glass shelf panel 604 stationary relative to the frame member 608.

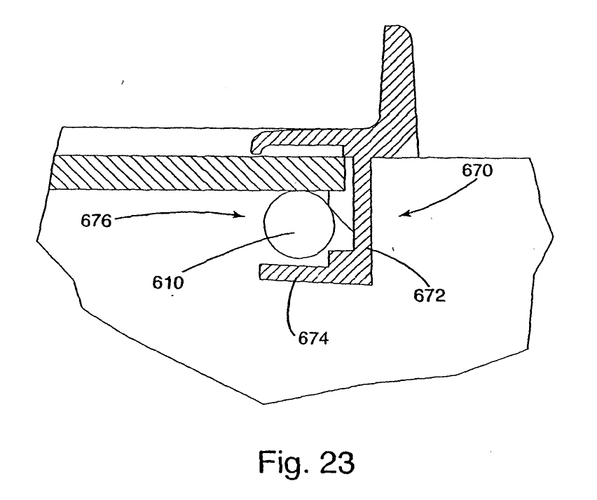

Further, and with reference to FIG. 23, the rear portion of the glass shelf panel 604 is supported through the use of a rear plastic rail 670 having a cross-sectional configuration as shown in FIG. 23. The rear plastic rail 670 includes a downwardly projecting section 672. Positioned at the terminating end of the downwardly projecting section 672 and integral therewith is a horizontally disposed section 674 which is substantially perpendicular to the section 672. The downwardly projecting member 672 and the horizontally disposed member 674 form a slot 676 as illustrated in FIG. 23.

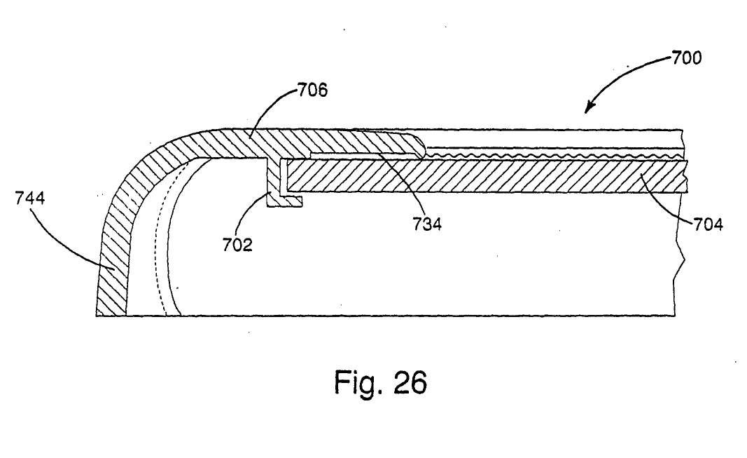

An alternative embodiment of a shelving assembly in accordance with the invention is illustrated in FIG. 26. Referring specifically to FIG. 26, the drawing of FIG. 26 illustrates, in part, a cross-section of the front or forward area of the plastic rim 706. This configuration is similar to the left-side portion of the drawing of FIG. 6. As with FIG. 6, the shelving assembly configuration 700 includes the plastic rim 706 with a projecting forward lip 744. The plastic rim 706 is secured to the glass shelf panel 704 through use of the adhesive 734. However, unlike the embodiment illustrated in FIG. 6, the shelving assembly 700 includes a support ledge 702 illustrated in cross section in FIG. 26. The support ledge 702 preferably extends along the entire periphery of the forward portion of the shelving assembly 700. Also, the shelving assembly 700 preferably includes (although not shown specifically in FIG. 26) the use of snaps on the remaining three sides of the shelf assembly 700. Such snaps can correspond in function and structure to the snaps 250 previously described with respect to FIG. 10. The primary purpose of the support ledge 702 is to facilitate retention of the glass shelf panel 704 within the entire shelving assembly. In addition, the support ledge 702 assists in stabilizing the glass shelf panel 704 during the process of assembly of the shelf panel 704, plastic rim 706 and the adhesive 734. As an alternative to use of the support ledge 702 in the forward portion of the shelving assembly 700, the support ledge 702 could alternatively be positioned at the rear portion of the shelving assembly 700.

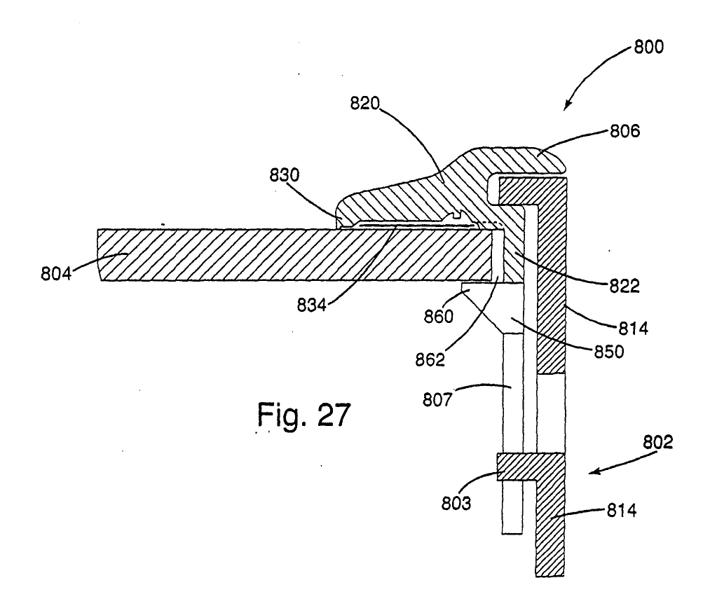

Still another feature of shelving assemblies in accordance with the invention, and as an alternative embodiment to those previously described herein, is the shelving assembly 800 illustrated in FIG. 27. The shelving assembly 800 is somewhat similar in scope to the shelving assembly 400 previously described herein with respect to FIG. 12. More specifically, the shelving assembly 800 includes a glass shelf panel 804, plastic rim 806 and metal frame with sideplates 814. In addition, an adhesive 834 is utilized to secure the glass shelf panel 804 to the plastic rim 806. Similar to FIG. 12, the shelving assembly 800 may also include a series of snaps 850. That is, and in a manner similar to FIG. 12, a horizontally disposed lower ledge 860 depends from the downwardly projecting member 822 of the plastic rim 806. The foregoing elements are substantially included within the shelving assembly 400 as illustrated in FIG. 12 and described in prior paragraphs hereof. However, distinguishable from shelving assembly 400, the shelving assembly 800 includes a plastic stop 807 depending downwardly from the lower and horizontally disposed ledge 860. The plastic stop 807 is associated with one of the snaps 850 positioned on one side of the shelving assembly 800, and one of the snaps 850 positioned on the opposing side of shelving assembly 800.

In addition to the plastic stops 807, the shelving assembly 800 also includes a horizontally and inwardly depending metal protrusion 803 which is preferably integral with the metal sideplate 814 and extending therefrom. The relative positioning of the metal protrusion 803 is as shown in FIG. 27. With the metal protrusion 803 and the plastic stop 807, the combination thereof provides for a stop mechanism for the feature of the shelving assembly 800 comprising slidable properties. That is, as the glass panel 804 and plastic rim 806 are slid forwardly on the metal cantilever frame 802, the provision of the plastic stop 807 on each side of the shelving assembly 800 abutting a metal protrusion 803 extending from the sideplate 814 (again on each side of the shelving assembly 800), prevents the plastic rim 806 and the glass shelf panel 804 from sliding off of the metal cantilever frame 802. Again, the plastic stops 807 are only associated with the snaps 850 which include the horizontally depending ledge 860. Still further, these plastic stops are only associated with two of the snaps located on opposing sides of the shelving assembly 800.

It should be emphasized that various configurations of the concept of providing “stop” features as illustrated in FIG. 27 for shelving assembly 800 may be modified without departing from the spirit and scope of the novel concepts of the invention. For example, the metal protrusion 803 may be punched out, formed, or fastened so as to be horizontally depending or vertically depending, as is desired with respect to the sideplate 814. As shown in FIG. 27, the metal protrusion 803 is horizontally depending. However, the metal protrusion 803 could, alternatively, be vertically depending, and bent in a manner so that the metal protrusion 803 was primarily in a vertical configuration. With the metal protrusion 803 in a vertical configuration, it can provide a greater cross sectional area for abutment against the plastic stop 803. In this matter, the “stop” feature may be somewhat enhanced.

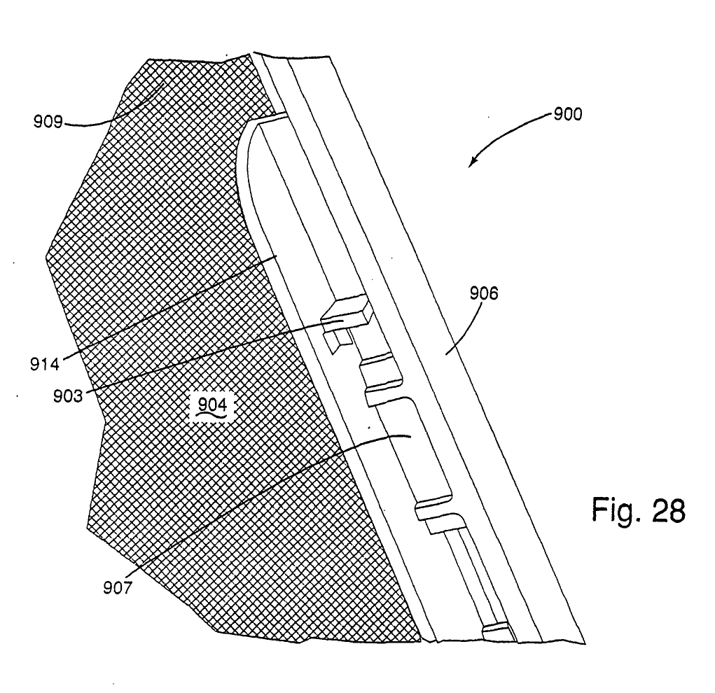

Another embodiment of a stop mechanism in accordance with the invention is illustrated in shelving assembly 900 as seen in FIG. 28. Shelving assembly 900 is similar in scope to shelving assembly 100 previously described in FIGS. 1-9. A plastic rim 906 is bonded to a glass shelf panel 904 through the use of an adhesive. A metal frame with outwardly depending sideplates 914 is utilized. However, inwardly depending sideplates and flat sideplates may also be utilized without departing from the novel concepts and the spirit and scope of the invention. Similar to shelving assembly 800 in FIG. 27, shelving assembly 900 as seen in FIG. 28 may utilize a sideplate 914 with a metal protrusion 903 that acts in combination with a plastic stop 907 that is integral with the plastic rim 906. The metal protrusion 903 and plastic stop 907 in shelving assembly 900 perform a similar function as the metal protrusion 803 and plastic stop 807 as described in FIG. 27. This stop mechanism can be utilized with the sliding shelving assemblies previously described herein. Also, as illustrated in FIG. 28, the glass shelf panel 904 may contain decoration 909 by means including but not limited to frosting, etching, or as is desired to conceal viewing of the adhesive on the underside of the shelving assembly 900. Various types of decoration may utilized on the shelving assemblies described herein without departing from the spirit and scope of the novel concepts of the invention.

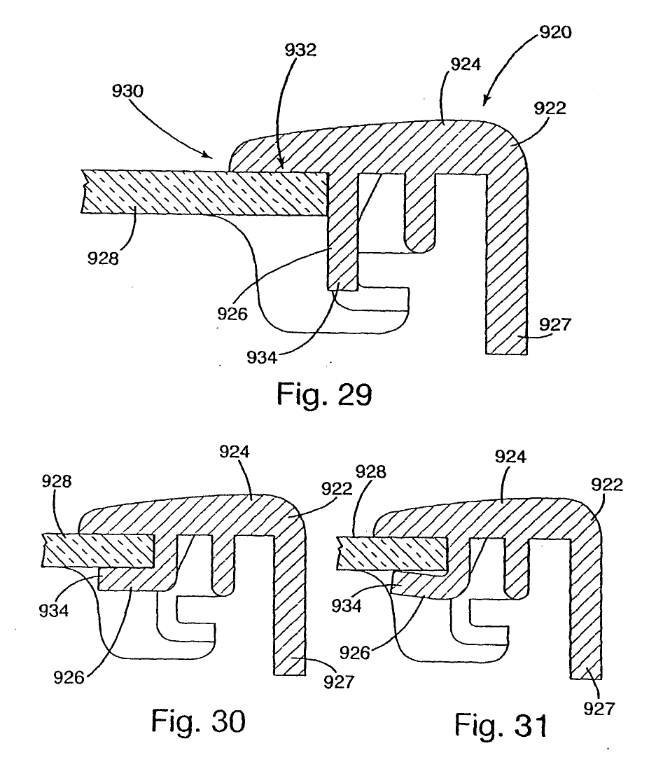

A still further embodiment of a shelving assembly in accordance with the invention is illustrated in part as shelving assembly 920 illustrated in FIGS. 29, 30 and 31. For purposes of clarity and brevity, the entirety of the shelf assembly 920 is not illustrated. In substantial part, the shelf assembly 920 is similar in design and construction to shelf assembly 200, 400 and 800 illustrated in FIGS. 10, 12 and 27, respectively. The distinctions of shelf assembly 920 relative to the other shelf assemblies resides in the use of heat stake principles for purposes of providing additional securing of the plastic rim to the glass shelf panel. More specifically, and with reference to FIGS. 29, 30 and 31, the shelving assembly 920 includes a plastic rim 922, somewhat similar in structure and function to the plastic rims 106, 206, et al. previously described herein. The plastic rim 922 includes a horizontally disposed section 924 and a downwardly projecting section 926. In accordance with the invention, extending downwardly, and integral with the horizontally disposed section 924 is a downwardly projecting section in the form of a heat stake rib 926. The heat stake rib 926 is adjacent the perimeter of the glass shelf panel 928. If desired, the shelving assembly 920 may also include a spatial area 930 formed between the plastic rim 922 and the glass shelf panel 928. Within the spatial area 930, an adhesive 932 may be provided so as to secure and couple together the glass shelf panel 928 and the plastic rim 922.

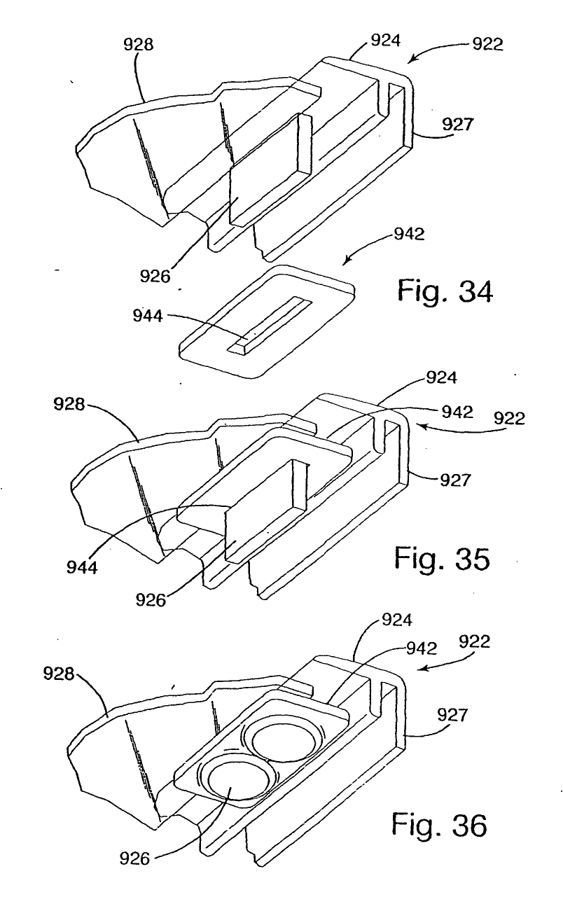

Further in accordance with the invention, a plurality of heat stake ribs 926 may be positioned at various locations on the front, back and sides (or combinations thereof) of the plastic rim 922. The entirety of a heat stake rib 926 is illustrated in partial perspective view in FIGS. 34 and 35. With reference to the shelving assembly 200 illustrated in FIG. 10, the heat stake ribs 926 replace the series of snaps 250 associated with the shelving assembly 200.

For purposes of assembly, the series of heat stake ribs 926 may be heated by appropriate means. When one of each of the heat stake ribs 926 is heated to an appropriate temperature, the ribs 926 become pliable and thus flexible. While in this heated state, each of the heat stake ribs 926 may be bent or curved so that a lower section 934 of each heat stake rib may be flexed inwardly toward and below the glass shelf panel 928. The process of heating the ribs 926 is conventionally referred to as “hot forming,” and is a practice which is known in the industrial arts. When the heat stake ribs 926 are appropriately formed toward and below the glass shelf panel 928, the ribs 926 take the form as illustrated in FIGS. 30 and 31. More specifically, FIG. 30 illustrates the positioning of the heat stake rib 926 after being hot formed with a small radius tool. Correspondingly, FIG. 31 illustrates the securing position of the heat stake rib 926 toward and below the glass shelf panel 928 after being hot formed with a large radius heat stake tool. In each case, the heat stake ribs 926 are formed over and onto the glass shelf panel 928. In this manner, the heat stake ribs 926 provide additional support for the glass shelf panel 928. In addition, the formation of the heat stake ribs 926 is such that the ribs 926 may be more readily formed with a greater length than the tabs of the snaps 250 previously described with respect to the shelving assembly 200. This additional length increases the supporting strength of the heat stake ribs 926 relative to the snaps 250.

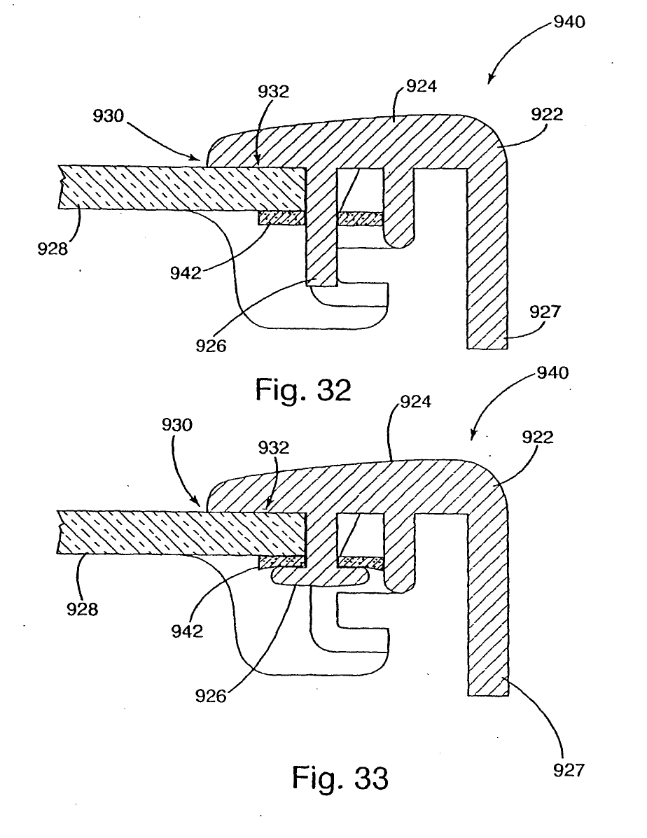

FIGS. 32-36 illustrate the use of the heat stake ribs 926, but with a particular means for hot forming the ribs 926 and a securing configuration distinguishable from the “bending over” of the ribs 926 relative to the glass shelf panel 928. More specifically, the shelving assembly illustrated in FIGS. 32-36 (identified as shelving assembly 940) is substantially similar to shelving assembly 920, but includes the use of additional elements identified as heat stake pads 942. A heat stake pad 942 or series of heat stake pads will be associated with each of the heat stake ribs 926 or series of heat stake ribs. The structural configuration of a heat stake pad 942 is best illustrated in FIG. 34. Specifically, each heat stake pad 942 may have a substantially rectangular configuration, with a relatively small thickness. The heat stake pads 942 may be constructed of various types of materials. For example, each heat stake pad 942 may be constructed of ABS plastic. As further illustrated in FIG. 34, each heat stake pad 942 includes a substantially rectangular aperture 944. Each aperture 944 is appropriately sized so as to fit the cross sectional configuration of a corresponding heat stake rib 926. For purposes of assembly, the heat stake pads 942 are appropriately positioned below the heat stake ribs 926 and then moved upwardly so that the corresponding heat stake rib 926 is received within the aperture 944 of the heat stake pad 942. This configuration is best illustrated in FIGS. 32 and 35. Each heat stake rib 926 or series of heat stake ribs may be appropriately heated by a heat stake tool (not shown). The heat stake tool may use various forms of heat. For example, the heat stake tool may use infra-red heat. The heat of the heat stake tool will cause each of the corresponding heat stake ribs 926 to increase in temperature. This increase in temperature will cause the heat stake ribs to become pliable. When the heat stake ribs 926 have reached an appropriate temperature, pressure can be exerted on the bottom portion of each heat stake rib 926 so as to cause the portion of each heat stake rib 926 located below the aperture 944 of a corresponding pad 942 to become deformed and “tightened” against the lower portion of the corresponding heat stake pad 942. This configuration is best illustrated in FIGS. 33 and 36. With this configuration, and as specifically illustrated in FIG. 33, the heat stake pad 942 abuts the lower portion of the glass shelf panel 928. When each of the heat stake pads 942 and ribs 926 cool back to an ambient temperature, the deformation of the lower portion of each heat stake rib 926 provides lower support of a corresponding one of the pads 942 in a manner so as to again provide additional support for the glass shelf panel 928. It should be emphasized that various types of heat stake ribs may be utilized, along with various types of heat stake pads. Also, various means for heating the ribs and pads may be utilized, without departing from any of the novel concepts of the invention.

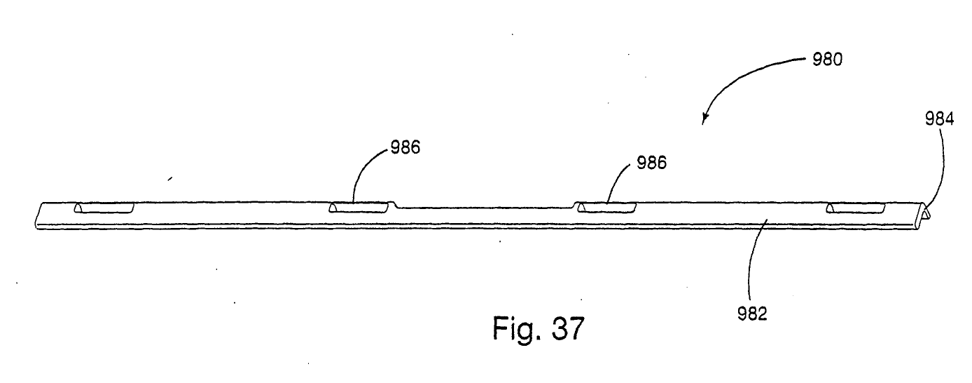

As an example of an alternative configuration for the heat stake pads, a heat stake pad 980 is illustrated in FIG. 37. The heat stake pad 980 is of an L-shaped configuration. More specifically, the heat stake pad 980 includes an elongated member 982. Positioned longitudinally along the elongated member 982 are a series of apertures 986. The apertures 986 have the same function as the aperture 944 previously described with respect to the heat stake pads 926 illustrated in FIGS. 34, 35 and 36. That is, the apertures 986 are adapted to receive the heat stake ribs 926. Still further, the heat stake pad 980 includes a leg member 984 which may be integral with the member 982 but extends perpendicularly thereto. When the heat stake pad 980 is appropriately positioned with heat stake ribs 926 appropriately received within the corresponding apertures 986, the elongated member 982 will abut the lower portion of a corresponding shelf panel as previously described with the heat stake pads 942.

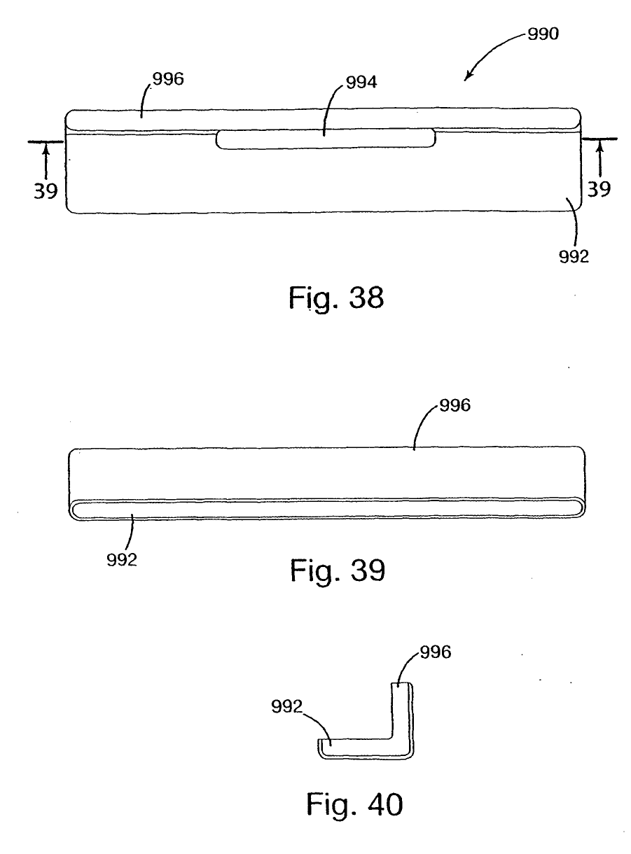

A further embodiment of a heat stake pad in accordance with the invention is illustrated in FIGS. 38, 39 and 40 as heat stake pad 990. The heat stake pad 990 is similar in construction to the heat stake pad 980, in that the heat stake pad 990 is of an L-shaped configuration. That is, the heat stake pad 990 includes a member 992 integral with or otherwise connected to a perpendicular leg member 996. However, unlike the heat stake pad 980 which includes a series of apertures 986 for receiving a series of heat stake ribs 926, the heat stake pad 990 includes only a single aperture 994. Correspondingly, the heat stake pad 990 is therefore adapted to receive only a single heat stake rib 926 through the aperture 994. When appropriately positioned relative to a shelf panel, and appropriately heated, the heat stake pad 990 will have its member 992 abutting the lower portion of the corresponding shelf panel.

It will be apparent to those skilled in the pertinent arts that other embodiments of shelving assemblies in accordance with the invention may be designed. That is, the principles of shelving assemblies in accordance with the invention are not limited to the specific embodiments described herein. Accordingly, it will be apparent to those skilled in the art that modifications and other variations of the above-described illustrative embodiments of the invention may be effected without departing from the spirit and scope of the novel concepts of the invention.

What is claimed is:

1. A shelving assembly adapted for use in a refrigerator and
other articles
employing shelving, characterized in that said shelving assembly comprises;
a shelf panel composed of glass;
a plastic rim sized and configured in a manner so as to provide for said plastic rim to be secured around at least a portion of the perimeter of said shelf panel; and
securing means adapted to be heated and made pliable so as to provide retention and support for said shelf panel.

2-13. (canceled)

14. A shelving assembly in accordance with claim 1,
characterized in that said
shelving assembly further comprises means comprising an adhesive located intermediate said plastic rim and said shelf panel, and providing for a leak-proof seal between said plastic rim and said shelf panel, and for rigidly securing said plastic rim to said shelf panel.

15. A shelving assembly in accordance with claim 14,
characterized in that
said retention and support provided by said securing means is additional to any retention and support provided through said use of said adhesive.

16-20. (canceled)

21. A shelving assembly in accordance with claim 14,
characterized in that: said shelving assembly further comprises at least one slot formed
between said plastic rim and said glass shelf panel;
said plastic rim comprises a flat plane;
within said at least one slot, said adhesive is provided so as to secure and couple
together said glass shelf panel and said plastic rim while providing a leak-proof barrier to liquids; and
said at least one slot aids in flow of said adhesive during the manufacturing process.

22. A shelving assembly in accordance with claim 14,
characterized in that
said adhesive comprises a reactive polyurethane hot melt or light cured acrylic adhesive.

23. (canceled)

24. A shelving assembly in accordance with claim 14, characterized in that said shelf panel includes decorative means for concealing the view of said adhesive.

25. A shelving assembly in accordance with claim 14,
characterized in that
said shelf panel is decorated with frosting or etching so as to conceal viewing of said adhesive.

26-32. (canceled)

33. A shelving assembly in accordance with claim 14,
characterized in that:
said plastic rim comprises a substantially horizontally disposed section, projecting
inwardly and terminating in a flat plane;
said flat plane provides for a spacial area formed between a lower surface of said horizontally disposed section and an upper surface of said glass shelf panel; and
said adhesive is provided within said spatial area, and utilized to facilitate securing of said glass shelf panel to said plastic rim.

34-43. (canceled)
